(19) United States
(12) Patent Application Publication
(10) Pub. No.: US 2024/0235602 A1
(43) Pub. Date: Jul. 11, 2024

(54) COMMUNICATION CIRCUITRY SUPPORTING MULTIPLE FREQUENCY BANDS AND ELECTRONIC DEVICE COMPRISING THE COMMUNICATION CIRCUIT

(71) Applicant: SAMSUNG ELECTRONICS CO., LTD., Suwon-si (KR)

(72) Inventors: Jonghun YOO, Suwon-si (KR); Hyoseok NA, Suwon-si (KR); John Moon, Suwon-si (KR)

(73) Assignee: SAMSUNG ELECTRONICS CO., LTD., Suwon-si (KR)

(21) Appl. No.: 18/609,745

(22) Filed: Mar. 19, 2024

Related U.S. Application Data
(63) Continuation of application No. PCT/KR2023/020338, filed on Dec. 11, 2023.

(30) Foreign Application Priority Data
Dec. 9, 2022 (KR) 10-2022-0171547
Jan. 9, 2023 (KR) 10-2023-0002712

(51) Int. Cl. H04B 1/48; H04B 1/00

(52) U.S. Cl. CPC H04B 1/48; H04B 1/0067

(57) ABSTRACT

An electronic device includes: a processor; a first radio frequency (RF) module; a second RF module; a coupler switch operatively connected to the first RF module and the second RF module; and a transceiver operatively connected to the processor, the coupler switch, and the first RF module, and the second RF module, wherein the coupler switch is configured to selectively switch between a first path in which a first feedback signal passes through the filter and a second path in which the second feedback signal is transferred to the transceiver without passing through the filter, and wherein the processor is configured to alternately connect the coupler switch to the first path or the second path, based on an operation mode.

### CROSS-REFERENCE TO RELATED APPLICATIONS

This application is a by-pass continuation application of International Application No. PCT/KR2023/020338, filed on Dec. 11, 2023, which is based on and claims priority to Korean Patent Application Nos. 10-2022-0171547, filed on Dec. 9, 2022, and 10-2023-0002712, filed on Jan. 9, 2023, in the Korean Intellectual Property Office, the disclosures of which are incorporated by reference herein their entireties.

### BACKGROUND

### 1. Field

The disclosure relates to a communication circuit supporting multiple frequency bands and an electronic device including the same.

### 2. Description of Related Art

A mobile communication service adopts evolved UMTS terrestrial radio access (E-UTRAN) new radio-dual connectivity (or dual-connectivity) (EN-DC) technology that simultaneously connects two or more communication signals (e.g., an long term evolution (LTE) network/fourth generation (4G) network and fifth generation (5G) network). To support an EN-DC function, an electronic device applies a radio frequency (RF) communication structure configured to simultaneously transmit at least two communication signals.

To provide a better communication environment, the electronic device may monitor the state of signals transmitted via an antenna. For example, the electronic device may extract part of a transmission signal output from an antenna by using a coupler. The electronic device may analyze the feature of a coupling signal (or a feedback signal), and may control an operation condition, which corresponds to a state desired by a transmission output end.

An electronic device that supports communication of multiple frequency bands may generate a feedback signal (or a coupling signal via a coupler) that corresponds to each frequency band. Accordingly, the electronic device applies a structure including a coupler to a transmission path of each RF module.

In implementation, a transceiver that analyzes a transmission signal may be designed to have a limited number of ports (e.g., one feedback receive (FBRX) port) configured to be connected to a coupler. The electronic device may need to perform path control among couplers respectively included in a plurality of RF communication modules. To this end, the electronic device may dispose a coupler switch between the transceiver and each coupler. The coupler switch may perform a switching operation with respect to a connection to each coupler so that each feedback signal (or a coupling signal) is transmitted to the transceiver in a time division manner.

However, although a switching operation that disconnects a connection to any one of the couplers and connects another coupler is performed in the state in which the electronic device simultaneously/together transmits multiple frequency bands, mutual interference may occur between feedback paths due to the limitation of an isolation feature of a switch device. Signal interference between feedback paths may distort a feedback signal input to the transceiver, and may cause an error when controlling output from a transmission end.

### SUMMARY

The technical subject matter of the document is not limited to the above-mentioned technical subject matter, and other technical subject matters which are not mentioned may be understood by those skilled in the art based on the following description.

According to an aspect of an embodiment, an electronic device includes: a processor; a first radio frequency (RF) module; a second RF module; a coupler switch operatively connected to the first RF module and the second RF module; and a transceiver operatively connected to the processor, the coupler switch, and the first RF module, and the second RF module, wherein the first RF module includes: a first amplifier configured to amplify signals of a first frequency band, and a first coupler configured to generate a first feedback signal with respect to the signals of the first frequency band, wherein the second RF module includes: a second amplifier configured to amplify signals of a second frequency band, and a second coupler configured to generate a second feedback signal with respect to the signals of the second frequency band, and wherein the coupler switch includes: a filter configured to pass the signals of the first frequency band and to attenuate the signals of the second frequency band, and a plurality of switches, wherein the coupler switch is configured to selectively switch between a first path in which the first feedback signal passes through the filter, the first feedback signal being transferred to the transceiver and a second path in which the second feedback signal is transferred to the transceiver without passing through the filter, and wherein the processor is configured to alternately connect the coupler switch to the first path or the second path, based on an operation mode for simultaneously/together transmitting the signals of the first frequency band and the signals of the second frequency band.

According to an aspect of an embodiment, a communication device for supporting multiple frequency bands, includes: a first radio frequency (RF) module; a second RF module; a coupler switch operatively connected to the first RF module and the second RF module; and a transceiver operatively connected to the first RF module, the second RF module, and the coupler switch, wherein the first RF module includes: a first amplifier configured to amplify signals of a first frequency band, and a first coupler configured to generate a first feedback signal with respect to the signals of the first frequency band; wherein the second RF module includes: a second amplifier configured to amplify signals of a second frequency band, and a second coupler configured to generate a second feedback signal with respect to the signals of the second frequency band; and wherein a coupler switch is configured to selectively transfer the first feedback signal or the second feedback signal to the transceiver based on a time division condition, wherein the coupler switch includes: a filter configured to pass the signals of the first frequency band to pass, and attenuate the signals of the second frequency band; a first switch configured to selectively connect an output end with a first path that passes through the filter and a second path that does not pass through the filter, wherein the output end is connected to the transceiver; a second switch configured to selectively connect an input end with the first path that passes through the filter and the second path that does not pass through the filter; a third switch configured to selectively connect the first coupler and the input end; and a fourth switch configured to selectively connect the second coupler and the input end.

An electronic device according to one or more embodiments may propose a structure in which a coupler switch, which controls a path between a coupler included in each of a plurality of RF communication module and a transceiver, includes a filter. Accordingly, in the state in which simultaneous transmission is performed in multiple frequency bands, an isolation feature between feedback signals may be improved and interference between feedback signals may be overcome.

An electronic device according to one or more embodiments may prevent an undesired signal of another frequency band from acting as signals that interferes at least a predetermined level with a feedback signal input to a transceiver, and may control output of a transmission end without distortion of the feedback signal.

Effects that could be obtained based on the disclosure are not limited to the above-described effects, and those skilled in the art would clearly understand other effects, which are not mentioned above, from the descriptions provided below.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an example electronic device in a network environment according to one or more embodiments;

FIG. 2 is a block diagram of an electronic device for supporting legacy network communication and 5G network communication according to one or more embodiments;

FIG. 3 is a diagram illustrating a configuration of a communication circuit of an electronic device according to a comparative example;

FIGS. 4A and 4B are diagrams illustrating examples of the configuration of an RF circuit of an electronic device according to one or more embodiments;

FIG. 5 is a diagram illustrating a frequency characteristic of a filter applied in the disclosure according to one or more embodiments;

FIGS. 6A and 6B are diagrams illustrating a coupler switching structure and a feedback signal path according to an output signal in the state of simultaneous transmission in multiple frequency bands according to one or more embodiments; and

FIG. 7 is a diagram illustrating the configuration of an RF circuit of an electronic device according to one or more embodiments.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

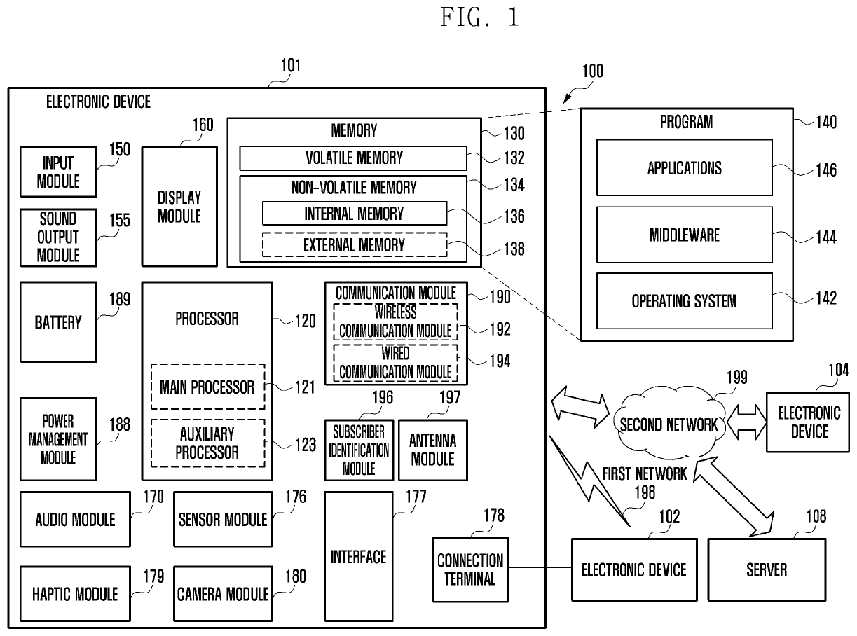

FIG. 1 is a block diagram illustrating an example electronic device in a network environment according to one or more embodiments.

Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In various embodiments, at least one (e.g., the display device 160 or the camera module 180) of the components may be omitted from the electronic device 101, or one or more other components may be added in the electronic device 101. In various embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted ‘Boltzmann machine (RBM), a deep belief network (DBN), a bidirectional recurrent deep neural network (BRDNN), deep Q-network or a combination of two or more thereof but is not limited thereto. The artificial intelligence model may additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196).

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

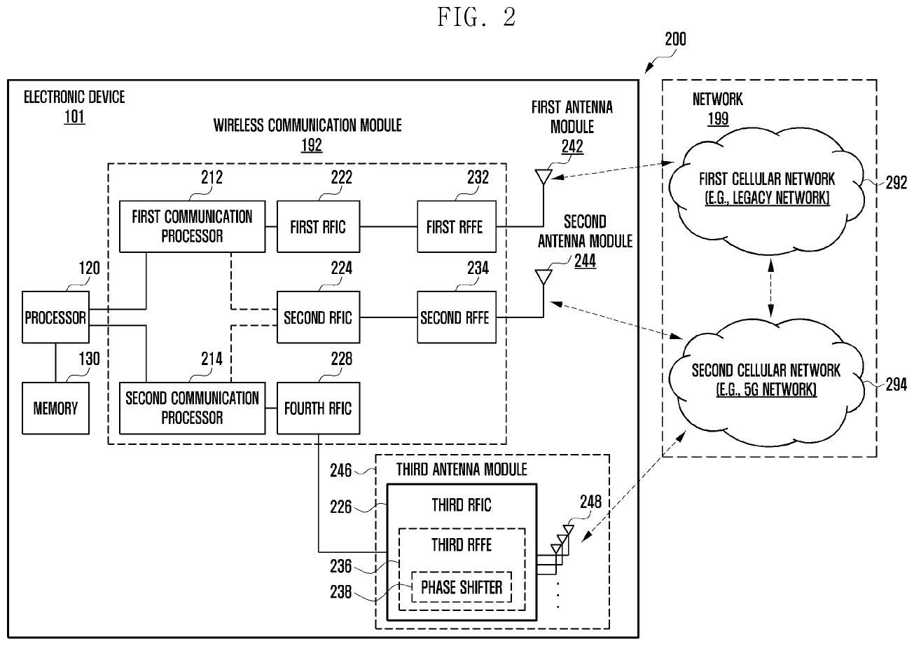

FIG. 2 is a block diagram of an electronic device for supporting legacy network communication and 5G network communication according to one or more embodiments.

Referring to FIG. 2, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include the processor 120 and the memory 130. The second network 199 may include a first cellular network 292 and a second cellular network 294. According to another embodiment, the electronic device 101 may further include at least one component among the components illustrated in FIG. 1, and the second network 199 may further include at least one other network. According to one or more embodiments, the first communication processor 212, the second communication processor 214, the first RFIC 222, the second RFIC 224, the fourth RFIC 228, the first RFFE 232, and the second RFFE 234 may be at least a part of the wireless communication module 192. According to another embodiment, the fourth RFIC 228 may be omitted, or may be included as a part of the third RFIC 226.

The first communication processor 212 may establish a communication channel of a band to be used for wireless communication with the first cellular network 292, and may support network communication via the established communication channel. According to one or more embodiments, the first network may be a legacy network including a 2G, 3G, 4G, or long term evolution (LTE) network. The second communication processor 214 may establish a communication channel corresponding to a designated band (e.g., approximately 6 GHz to 60 GHz) among bands to be used for wireless communication with the second cellular network 294, and may support 5G network communication via the established communication channel. According to one or more embodiments, the second cellular network 294 may be a 5G network defined in 3GPP. Additionally, according to one or more embodiments, the first communication processor 212 or the second communication processor 214 may establish a communication channel corresponding to another designated band (e.g., 6 GHz or less) among bands to be used for wireless communication with the second cellular network 294, and may support 5G network communication via the established channel. According to one or more embodiments, the first communication processor 212 and the second communication processor 214 may be embodied in a single chip or a single package. According to one or more embodiments, the first communication processor 212 or the second communication processor 214 may be embodied in a single chip or a single package together with the processor 120, the auxiliary processor 123, or the communication module 190.

In the case of transmission, the first RFIC 222 may convert a baseband signal generated by the first communication processor 212 into a radio frequency (RF) signal in the range of approximately 700 MHz to 3 GHz used for the first cellular network 292 (e.g., a legacy network). In the case of reception, an RF signal is obtained from the first cellular network 292 (e.g., a legacy network) via an antenna (e.g., the first antenna module 242), and may be preprocessed via an RFFE (e.g., the first RFFE 232). The first RFIC 222 may convert a preprocessed RF signal into a baseband signal so that the signals is processed by the first communication processor 212.

In the case of transmission, the second RFIC 224 may convert a baseband signal generated by the first communication processor 212 or the second communication processor 214 into an RF signal (hereinafter, a 5G Sub6 RF signal) in an Sub6 band (e.g., approximately 6 GHz or less) used in the second cellular network 294 (e.g., a 5G network). In the case of reception, a 5G Sub6 RF signal is obtained from the second cellular network 294 (e.g., a 5G network) via an antenna (e.g., the second antenna module 244), and may be preprocessed by an RFFE (e.g., the second RFFE 234). The second RFIC 224 may convert a preprocessed 5G Sub6 RF signal into a baseband signal so that the signals may be processed by a corresponding communication processor among the first communication processor 212 or the second communication processor 214.

The third RFIC 226 may convert a baseband signal generated by the second communication processor 214 into an RF signal (hereinafter, a 5G Above6 RF signal) of a 5G Above6 band (e.g., approximately 6 GHz to 60 GHz) to be used in the second cellular network 294 (e.g., a 5G network). In the case of reception, a 5G Above6 RF signal is obtained from the second cellular network 294 (e.g., a 5G network) via an antenna (e.g., the antenna 248) and may be preprocessed by the third RFFE 236. The third RFIC 226 may convert a preprocessed 5G Above6 RF signal into a baseband signal so that the signals is processed by the second communication processor 214. According to one or more embodiments, the third RFFE 236 may be embodied as a part of the third RFIC 226.

The electronic device 101, according to one or more embodiments, may include the fourth RFIC 228, separately from the third RFIC 226 or as at least a part of the third RFIC 226. In this instance, the fourth RFIC 228 may convert a baseband signal generated by the second communication processor 214 into an RF signal (hereinafter, an IF signal) in an intermediate frequency band (e.g., approximately 9 GHz to 11 GHz), and may transfer the IF signal to the third RFIC 226. The third RFIC 226 may convert an IF signal into a 5G Above6 RF signal. In the case of reception, a 5G Above6 RF signal may be received from the second cellular network 294 (e.g., a 5G network) via an antenna (e.g., the antenna 248) and may be converted into an IF signal by the third RFIC 226. The fourth RFIC 228 may convert an IF signal into a baseband signal so that the signals is processed by the second communication processor 214.

According to one or more embodiments, the first RFIC 222 and the second RFIC 224 may be embodied as at least a part of a single chip or a single package. According to one or more embodiments, the first RFFE 232 and the second RFFE 234 may be embodied as at least a part of a single chip or a single package. According to one or more embodiments, at least one antenna module of the first antenna module 242 or the second antenna module 244 may be omitted, or may be coupled with another antenna module, so as to process RF signals in multiple bands.

According to one or more embodiments, the third RFIC 226 and the antenna 248 may be disposed in the same substrate so as to configure a third antenna module 246. For example, the wireless communication module 192 or the processor 120 may be disposed in a first substrate (e.g., a main PCB). In this instance, the third RFIC 226 is disposed in a part (e.g., an under surface) of a second substrate (e.g., a sub PCB) different from the first substrate and the antenna 248 is disposed on another part (e.g., an upper surface), so that the third antenna module 246 may be configured. By disposing the third RFIC 226 and the antenna 248 in the same substrate, the length of a transmission line therebetween may be reduced. For example, this may reduce loss (e.g., attenuation) of a high-frequency band signal (e.g., approximately 6 GHz to 60 GHz) used for 5G network communication, the loss being caused by a transmission line. Accordingly, the electronic device 101 may increase the quality or speed of communication with the second cellular network 294 (e.g., a 5G network).

According to one or more embodiments, the antenna 248 may be configured as an antenna array including a plurality of antenna elements which may be used for beamforming. In this instance, the third RFIC 226, for example, may include a plurality of phase shifters 238 corresponding to a plurality of antenna elements, as a part of the third RFFE 236. In the case of transmission, each of the plurality of phase shifters 238 may shift the phase of a 5G Above6 RF signal to be transmitted to the outside of the electronic device 101 (e.g., a base station of a 5G network) via a corresponding antenna element. In the case of reception, each of the plurality of phase shifters 238 may shift the phase of a 5G Above6 RF signal received from the outside via a corresponding antenna element into the same or substantially the same phase. This may enable transmission or reception via beamforming between the electronic device 101 and the outside.

The second cellular network 294 (e.g., a 5G network) may operate independently (e.g., stand-alone (SA)) from the first cellular network 292 (e.g., a legacy network) or may operate by being connected thereto (e.g., non-stand alone (NSA)). For example, in the 5G network, only an access network (e.g., a 5G radio access network (RAN) or next generation RAN (NG RAN)) may be included, and a core network (e.g., a next generation core (NGC)) may not be included. In this instance, the electronic device 101 may access the access network of the 5G network, and may access an external network (e.g., the Internet) according to control performed by a core network (e.g., an evolved packed core (EPC)) of a legacy network. Protocol information (e.g., LTE protocol information) for communication with a legacy network or protocol information (e.g., New Radio (NR) protocol information) for communication with the 5G network may be stored in the memory 230, and may be accessed by another component (e.g., the processor 120, the first communication processor 212, or the second communication processor 214).

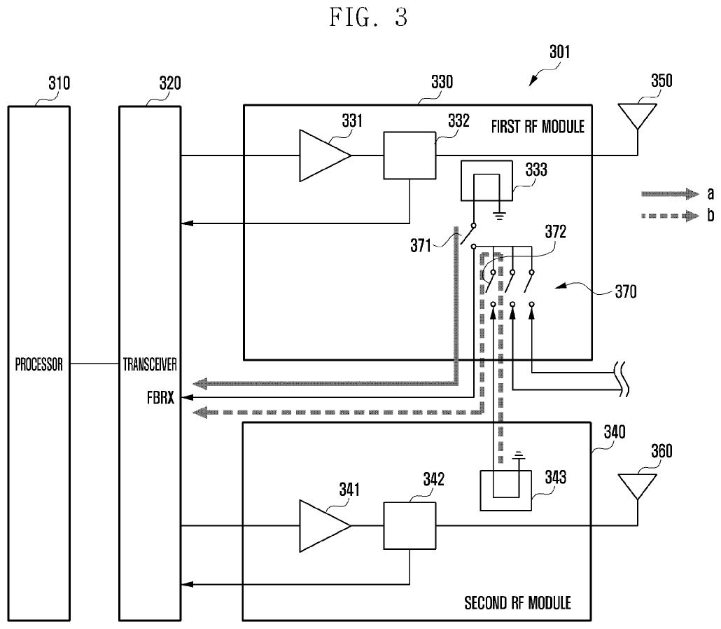

FIG. 3 is a diagram illustrating the configuration of a communication circuit of an electronic device according to a comparative example.

Referring to FIG. 3, an electronic device 301 according to a comparative example (or a conventional example) may include a processor 310, a transceiver 320, a first RF module 330, a second RF module 340, a first antenna 350, and a second antenna 360. Each RF module may include an amplifier 331 and 341 that amplifies a signal, a duplexer 332 and 342 that separates a transmission signal and a reception signal, and a coupler 333 and 343 for monitoring a signal in an RF path.

The electronic device 301 of the comparative example may support a plurality of RF frequency bands. For example, the electronic device 301 may simultaneously/together transmit two transmission signals via the first RF module 330 and the second RF module 340, and may dispose the first coupler 333 in the RF module 330 and the second coupler 343 in the second RF module 340, in order to monitor transmission signals.

In the electronic device 301 of the comparative example, since the transceiver 320 is embodied to have a limited number of ports (e.g., one feedback receive (FBRX) port) configured to be connected to a coupler, a coupler switch 370 that controls a path of a feedback signal coupled by a coupler may be disposed in a feedback path. The coupler switch 370 illustrated in FIG. 3 is an example embodied as switches for controlling paths associated with couplers included in other RF modules, in addition to path control performed between the first coupler 333 and the second coupler 343. However, path control performed between the first coupler 333 and the second coupler 343 will be described.

In the state in which the electronic device 301 simultaneously/together performs transmission in multiple frequency bands in the example of FIG. 3, the processor 310 may turn on a first switch 371 and may turn off the second switch 372 in order to input a first feedback signal (e.g., FB_1) generated by the first coupler 333 to the transceiver 320 in a first time interval. The first feedback signal (e.g., FB_1) may be input to the transceiver 320 via a first path a.

The processor 310 may turn off the first switch 371 and may turn on the second switch 372 in order to input a second feedback signal (e.g., FB_2) generated by the second coupler 343 to the transceiver 320 in a second time interval. The second feedback signal (e.g., FB_2) may be input to the transceiver 320 via a second path b.

The processor 310 may perform control so as to repeat the first path a or the second path b at regular intervals according to a time division condition in the state in which transmission is simultaneously/together performed in multiple frequency bands. For example, the transceiver 320 may receive a first feedback signal (e.g., FB_1) via the first path a and then receive a second feedback signal (e.g., FB_2) via the second path b at regular intervals via a single port (e.g., FBRX).

However, in case of the electronic device 301 of the comparative example, although the second switch 372 in the first path a is in a turned-off state, part of a second feedback signal (e.g., FB_2) may be provided to the first path a due to an isolation feature of a switch. For example, in the state in which a first feedback signal (FB_1) is output to the transceiver 320 via the coupler switch 370, in a case that part of a second feedback signal (e.g., FB_2) flows in the first path a, signal interference may occur. Accordingly, the transceiver 320 may not accurately analyze output of the first feedback signal (e.g., FB_1) and a signal characteristic, and thus an error may occur in control of a first transmission signal.

Hereinafter, the structure of a communication circuit of an electronic device (e.g., the electronic device 101 of FIG. 1 and FIG. 2) proposed in one or more embodiments of the disclosure in order to reduce signal interference occurring in a feedback path will be described.

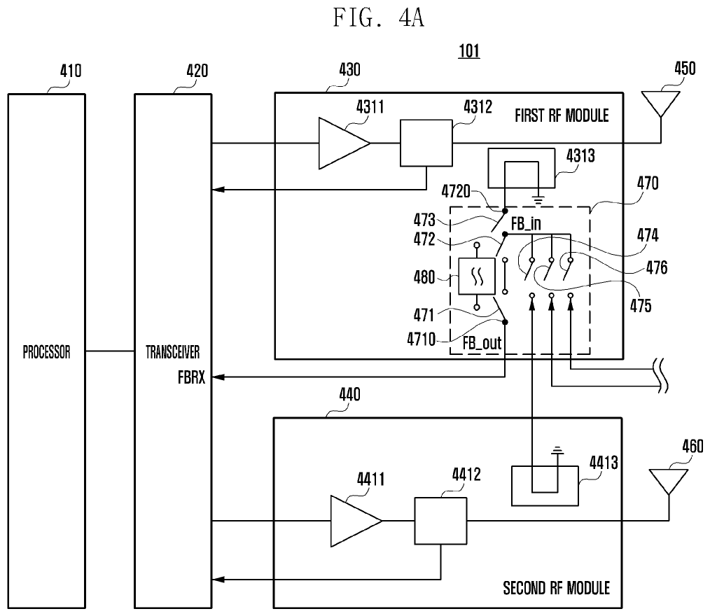

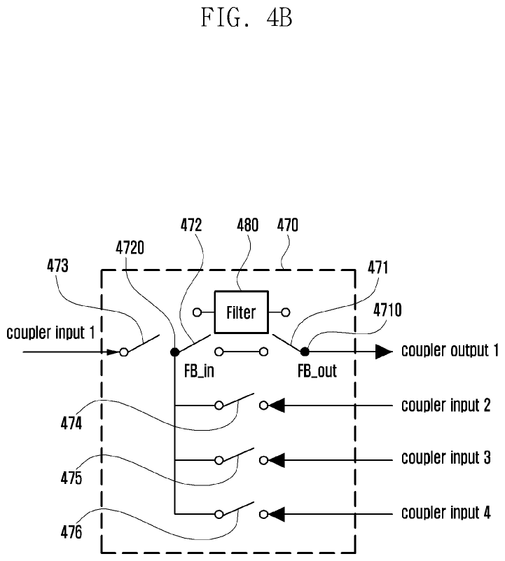

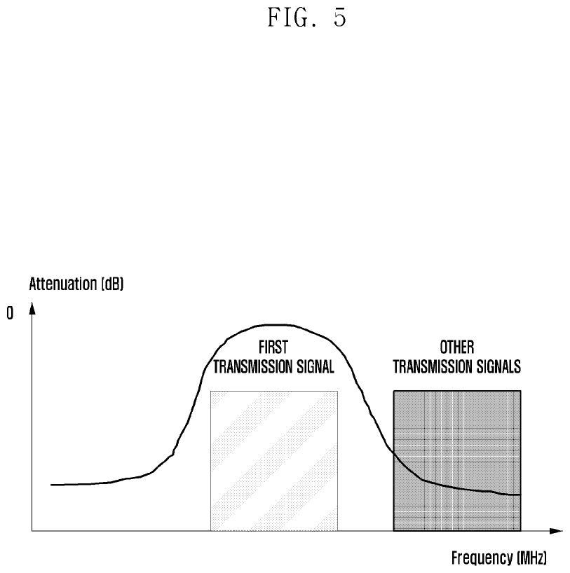

FIGS. 4A and 4B are diagrams illustrating examples of the configuration of an RF circuit of an electronic device according to one or more embodiments, and FIG. 5 is a diagram illustrating a frequency characteristic of a filter applied in the disclosure according to one or more embodiments.

Referring to FIGS. 4A and 4B, an electronic device (e.g., the electronic device 101 of FIG. 1 or the electronic device 101 of FIG. 2) according to one or more embodiments or a communication device may include a processor 410 (e.g., the processor 120 of FIG. 1, the first communication processor 212 of FIG. 2, or the second communication processor 214 of FIG. 2), a transceiver 420 (e.g., the first RFIC 222 of FIG. 2, the second RFIC 224, or the fourth RFIC 228), a first RF module 430 (e.g., the first RFFE 232 of FIG. 2), a second RF module 440 (e.g., the second RFFE 234 of FIG. 2), a first antenna 450 (e.g., the first antenna module 242 of FIG. 2), a second antenna 460 (e.g., a second antenna module 244 of FIG. 2, a third antenna module 246), and/or a coupler switch 470.

According to one or more embodiments, the electronic device 101 may support communication of a plurality of RF frequency bands. In addition, when the electronic device 300 is designed, components used for wireless communication may be modularized in order to increase convenience of development and/or an installation area.

According to one or more embodiments, the processor 410 may perform various control operations related to wireless communication with a network (e.g., the first cellular network 292 or the second cellular network 294 of FIG. 2). For example, the processor 410 may establish a communication channel, and may perform various control operations for wireless communication with an external device (e.g., a 5G base station) using the established channel. A baseband signal that is generated from the processor 410 may be transmitted to the transceiver 420.

According to one or more embodiments, the processor 410 may control switching operations of the coupler switch 470 according to operation of the first RF module 430 and/or the second RF module 440. For example, in the state of performing simultaneous transmission in multiple frequency bands, the processor 410 may control a switching operation of the coupler switch 470 so that a feedback signal of each RF module (e.g., the first RF module 430 and the second RF module 440) is input to a feedback input port (e.g., FBRX) of the transceiver 420 alternately according to a time division interval.

According to one or more embodiments, the transceiver 420 may perform various types of processing when outputting signals, received from the processor 410, via the first antenna 450 and/or the second antenna 460 or when providing signals, received from the first antenna 450 and/or the second antenna 460, to the processor 410. For example, the transceiver 420 may perform a frequency modulation operation that converts a baseband signal into a radio frequency (RF) signal used for cellular communication, may perform a frequency demodulation operation that converts a radio frequency (RF) signal into a baseband signal, and/or may perform an operation of converting the phase of signals.

According to one or more embodiments, in order to support a communication scheme using at least two frequency bands, the electronic device 101 may include at least two RF modules (e.g., the first RF module 430 and the second RF module 440).

Although the example of FIG. 4A describes that the electronic device 101 includes the first RF module 430 and the second RF module 440, the electronic device 101 is not limited thereto and may include three or more RF modules. For example, the electronic device 101 may include three RF modules in order to support all signals of three frequency bands (e.g., band B1 (1920 to 1980 MHz), band B2 (1850 to 1910 MHz), and band B3 (1710 to 1785 MHz)).

According to one or more embodiments, the electronic device 101 may include at least one antenna 450 and 460. Although the example of FIG. 4A illustrates that the first antenna 450 and/or the second antenna 460 is disposed, the electronic device 101 may include three or more antennas. According to one or more embodiments, a plurality of antennas may be connected to a single RF module. According to one or more embodiments, the first antenna 450 and/or the second antenna 460 may include an array antenna including a plurality of antenna elements.

According to one or more embodiments, the first RF module 430 and the second RF module 440 may support dual connectivity communication using different types of cellular communication (e.g., 4G LTE, 5G NR), or may support carrier aggregation communication using multiple frequency bands.

According to one or more embodiments, the first RF module 430 and the second RF module 440 may be referred to as an RF front end module or a Tx/Rx module.

The first RF module 430 and the second RF module 440 may include various configurations (e.g., an amplifier, a low-noise amplifier, a switch, a filter, and/or a coupler) that may amplify signals transferred from the transceiver 320, may process an amplified signal, and may perform low-noise amplification and processing of signals transferred from an antenna (e.g., the first antenna 450 and/or the second antenna 460).

Although the example of FIG. 4A schematically describes the structures of couplers (e.g., a first coupler 4313 and a second coupler 4413) that monitor signals of respective frequency bands in association with the first RF module 430 and the second RF module 440, and the structure of the coupler switch 470, it is apparent that component elements other than the illustrated component elements are included in each RF module (e.g., the first RF module 430 and the second RF module 440).

For example, the first RF module 430 may include a first amplifier 4311, a first duplexer 4312, and the first coupler 4313. The first amplifier 4311 may amplify signals (e.g., Tx 1) of a first frequency band transmitted by the transceiver 420. The amplified signals of the first frequency band may be transmitted to the first antenna 450 via the first duplexer 4312. The first duplexer 4312 may separate the path of a transmission signal (Tx 1) and a reception signal (Tx 2) so that a transmission signal transferred from the first amplifier 4311 is output to the side of the first antenna 450 and a reception signal transferred from the first antenna 450 is output to the transceiver 420. The first coupler 4313 may be disposed in an RF signal path and may monitor a first frequency band signal (e.g., Tx 1) that is transferred to the first antenna 450 or that is output from the first antenna 450. Based on a coupling phenomenon based on inductive coupling, the first coupler 4313 may output a coupling signal (e.g., a first feedback signal (FB_1) in a level lower than that of signals (e.g., Tx 1) of the first frequency band.

For example, the second RF module 440 may include a second amplifier 4411, a second duplexer 4412, and the second coupler 4413. The second frequency band may be, for example, a band different from the first frequency band. The second amplifier 4411 may amplify signals (e.g., Tx 2) of the second frequency band transmitted by the transceiver 420. The amplified signals of the second frequency band may be transmitted to the second antenna 460 via the second duplexer 4412. The second duplexer 4412 may separate the path of a transmission signal (Tx 2) and a reception signal (Tx 2) so that a transmission signal transferred from the second amplifier 4411 is output to the second antenna 460 and a reception signal transferred from the second antenna 460 is output to the transceiver 420. The second coupler 4413 may be disposed in an RF signal path and may monitor a second frequency band signal (e.g., Tx 2) that is transferred to the second antenna 460 or that is output from the second antenna 460. Based on a coupling phenomenon based on inductive coupling, the second coupler 4413 may output a coupling signal (e.g., a second feedback signal (FB_2)) in a level lower than that of a second frequency band signal (e.g., Tx 2).

According to one or more embodiments, the first coupler 4313 and the second coupler 4413 may include various couplers, for example, a coupled line coupler, a quadrature hybrid coupler, or the like. For example, the first coupler 4313 and the second coupler 4413 may output at least one of a forward (FWD) coupling signal coupled in association with a transmission signal in the direction of an antenna and/or a reverse (RVS) coupling signal coupled in association with a reception signal output from an antenna.

Although the examples of FIG. 4A and FIG. 4B describe that the coupler switch (or a coupler switch module) 470 is included in the first RF module 430 of the electronic device 101, the disclosure is not limited thereto. For example, the coupler switch 470 illustrated in FIG. 4A and 4B is an example embodied as switches (e.g., a fifth switch 475, a sixth switch 476) for controlling paths associated with couplers installed in other RF modules, in addition to path control performed between the first coupler 4313 and the second coupler 4413. A coupler included in each RF module may be connected to a switch (e.g., the fifth switch 475, the sixth switch 476) included in the coupler switch 470.

Hereinafter, the structure of a coupler switch will be described with reference to FIG. 4B.

Referring to FIG. 4B, according to one or more embodiments, the coupler switch 470 may include a plurality of switches (e.g., switches 471, 472, 473, 474, 475, and 476) and a filter 480. For example, the first switch 471 and the second switch 472 may be embodied in single-pole-double-throw (SP2T) structures, and the third switch to the sixth switch 473, 474, 475, and 476 may be embodied in single-pole-single-through (SPST) structures.

According to one or more embodiments, the coupler switch 470 may perform a function of selectively connecting (or switching between) the transceiver 420 and the first coupler 4313 or the second coupler 4413, and may perform a function of switching a first path that passes signals in the path through a filter or a second path that does not pass through a filter.

According to one or more embodiments, the filter 480 may include a filter (e.g., a band pass filter) having a feature that allows the first frequency band to pass through the filter and attenuates other frequency bands. For example, as illustrated in FIG. 5, the filter 480 may have a feature that enables the first frequency band corresponding to a first transmission signal to through the filter, and that attenuates a transmission signal of a frequency band other than the first frequency band.

According to one or more embodiments, the filter 480 may be selectively connected to an output end (FB_out) 4710 of the coupler switch 470 via the first switch 471, and may be selectively connected to an input end (FB_in) 4720 of the coupler switch 470 via the second switch 472.

The output end (FB_out) 4710 of the coupler switch 470 may be connected to the transceiver 420 and may be selectively connected to the filter 480 via the first switch 471. The number of ports is limited, and thus the transceiver 420 may only include a single port (e.g., FBRX) to receive a feedback signal. The transceiver 420 may alternately receive a feedback signal of the first coupler 4313 or the second coupler 4413 according to a time division interval, in response to switching by the coupler switch 470. For example, according to control performed by the processor 410, the coupler switch 470 may enable a first feedback signal (FB_1) or a second feedback signal (FB_2) to be transmitted to the transceiver 420 in a time division manner via a switching operation performed by each switch (e.g., switches 471, 472, 473, 474, 475, and 476).

According to one or more embodiments, the input end (FB_in) 4720 of the coupler switch 470 may be selectively connected to the filter 480 via the second switch 472, and may be connected to each coupler (e.g., the first coupler 4313, the second coupler 4413) via the third switch 473, the fourth switch 474, the fifth switch 475, and the sixth switch 476.

According to one or more embodiments, the coupler switch 470 may perform switching based on a transmission path associated with a frequency band of a transmission signal under control performed by the processor 410. For example, according to a switch connection structure, the coupler switch 470 may alternately output, to the transceiver 420, a first feedback signal (FB_1) of the first frequency band that is coupled by the first coupler 4313 or may output, to the transceiver 420, a feedback signal (FB_2) of the second frequency band that is coupled by the second coupler 4413.

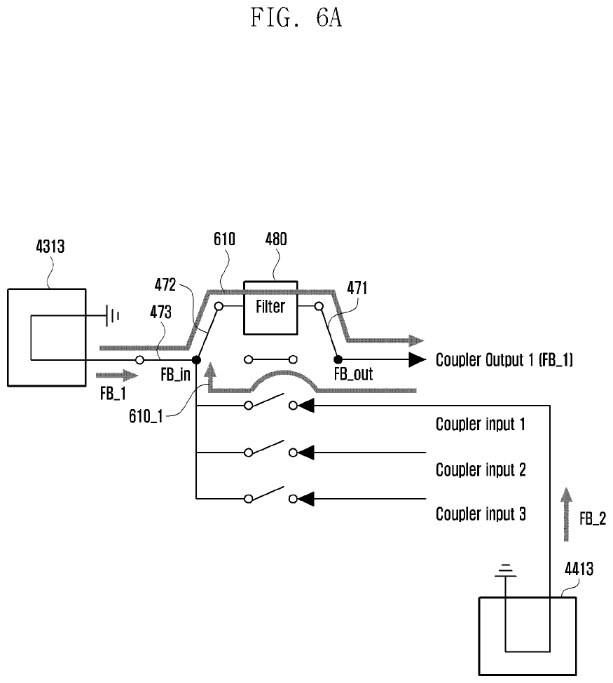

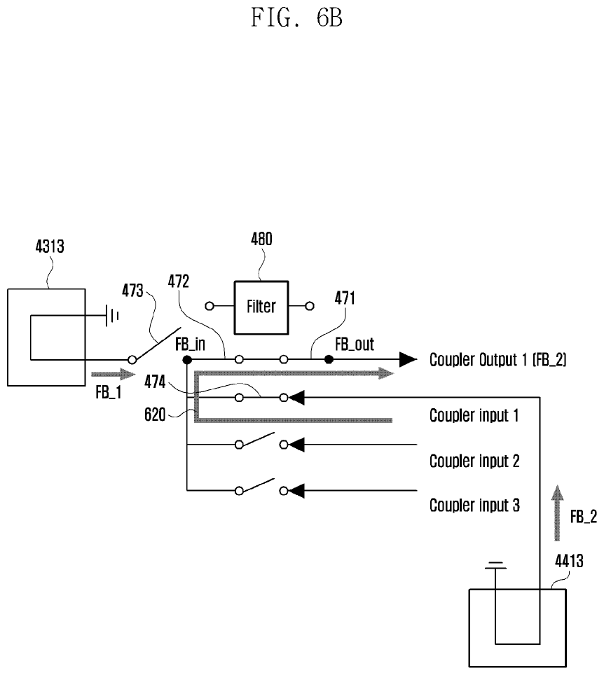

FIG. 6A is a diagram illustrating a coupler switching structure and a feedback signal path according to an output signal in the state of simultaneous transmission in multiple frequency bands according to one or more embodiments, and FIG. 6B is a diagram illustrating a coupler switching structure and a feedback signal path according to an output signal in the state of simultaneous transmission in multiple frequency bands according to one or more embodiments.

According to one or more embodiments, an electronic device (e.g., the electronic device 101 of FIG. 1 or the electronic device 101 of FIG. 2) may simultaneously/together support communication in a first frequency band and communication in a second frequency band via a first RF module (e.g., the first RF module 430 of FIG. 4A/B) and a second RF module (e.g., the second RF module 440 of FIG. 4A/B). The first RF module 430 may output a transmission signal of the first frequency band via a first antenna (e.g., the first antenna 450 of FIG. 4A/B), and simultaneously/together, the second RF module 440 may output a transmission signal of the second frequency band via a second antenna (e.g., the second antenna 460 of FIG. 4A/B).

According to one or more embodiments, a processor of the electronic device 101 (e.g., the processor 120 of FIG. 1, the first communication processor 212 of FIG. 2 or the second communication processor 214 of FIG. 2, the processor 410 of FIG. 4A) may control a switching operation of the coupler switch 470 to alternatively switch between the structure of FIG. 6A and the structure of FIG. 6B in the state of simultaneous transmission in multiple frequency bands, and may transfer a first feedback signal (FB_1) to a transceiver (e.g., the transceiver 420 of FIG. 4A) or may transfer a second feedback signal (FB_2) to the transceiver 420. Depending on the case, the processor 410 may control feedback paths of couplers in other RF modules. Hereinafter, a feedback path between the first coupler 4313 and the second coupler 4413 will be described in the following description.

The example of FIG. 6A may be a switching connection structure when the first RF module 430 and the second RF module 440 operate simultaneously/together, and a first feedback signal (FB_1) coupled through a first transmission signal is output as an output signal (coupler output 1=FB_1) of an output end (FB_1).

According to one or more embodiments, in a case that a first feedback signal (FB_1) coupled by the first coupler 4313 is output to a port (e.g., FBRX) of the transceiver 420, the processor 410 may turn on (ON) the third switch 473 that connects an input end (FB_in) and the first coupler 4313, and may turn on (ON) the first switch 471 and the second switch 472 to connect a first path 610 that passes through a filter, and thus may connect an output end (FB_out) and the transceiver 420. In this instance, the processor 410 may perform control so as to turn off (OFF) the fourth switch 474 that connects the input end (FB_1) and the second coupler 4413. In a case that another RF module is connected, the processor 410 may perform control so as to turn off the fifth switch 475 and the sixth switch 476.

A first feedback signal (FB_1) coupled by the first coupler 4313 may be input to the input end (FB_in), and may proceed along the first path 610 illustrated in FIG. 6A, so that the signals may pass through the filter 480, may be output as coupler output 1 of the output end (FB_out), and may be transferred to the transceiver 420.

Although the second RF module 440 simultaneously/together operates and the fourth switch 474 connected to the second coupler 4313 is turned off in the electronic device 101, part of a second feedback signal (FB_2) may flow in the first path 610 via a path 610_1 from a port (e.g., coupler input 1) connected to the second coupler 4413, due to the isolation feature of a switch as illustrated in FIG. 6A. According to one or more embodiments, the filter 480 may have a feature that attenuates a transmission signal in a frequency band other than a frequency band of a first transmission signal, and thus may filter out the second feedback signal (FB_2) that flows in the first path 610. Accordingly, in the state of simultaneous transmission in multiple frequency bands, the electronic device 101 may reduce an error incurred by interference of a coupled signal component.

The example of FIG. 6B may be a switching connection structure when the first RF module 430 and the second RF module 440 operate simultaneously/together, and a second feedback signal (FB_2) coupled by a second transmission signal is output as an output signal (coupler output 1=FB_2) of the output end (FB_out).

According to one or more embodiments, in a case that a second feedback signal (FB_2) coupled by the second coupler 4413 is output to the transceiver 420, the processor 410 may turn on (ON) the fourth switch 474 that connects the input end (FB_in) and the second coupler 4413 and may turn on (ON) the first switch 471 and the second switch 472 to connect the second path 620 that does not pass through a filter, and thus may connect the second coupler 4413 and the transceiver 420. In this instance, the processor 410 may perform control so as to turn off (OFF) the third switch 473 that connects the input end (FB_in) and the first coupler 4313. In a case that another RF module is connected, the processor 410 may perform control so as to turn off (OFF) the fifth switch 475 and the sixth switch 476.

A second feedback signal (FB_2) coupled by the second coupler 4413 may be input as coupler input 1 to the input end (FB_in) and may proceed along the second path 620 illustrated in FIG. 6B, so that the signals may not pass through the filter 480, may be output as coupler output 1 of the output end (FB_out), and may be transferred to the transceiver 420.

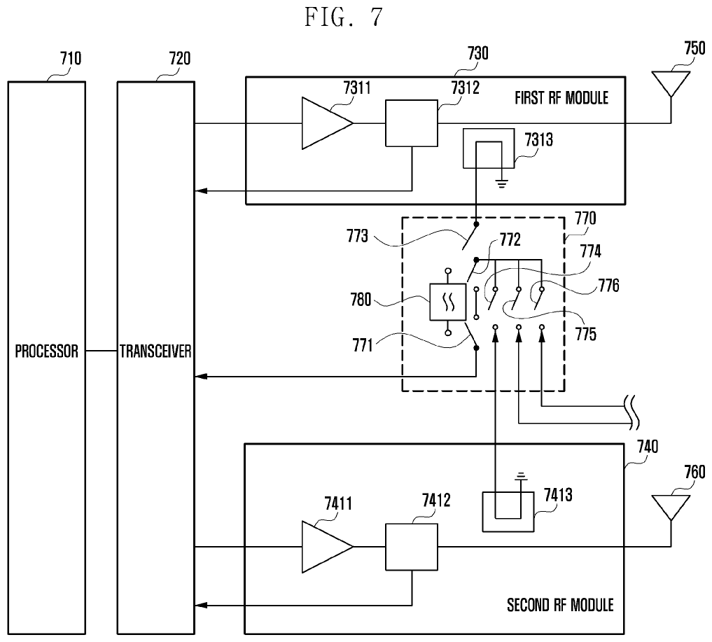

FIG. 7 is a diagram illustrating the configuration of an RF circuit of an electronic device according to one or more embodiments.

Referring to FIG. 7, an electronic device 101 according to one or more embodiments may include a processor 710, a transceiver 720, a first RF module 730, a second RF module 740, a first antenna 750, a second antenna 760, and a coupler switch 770. The first RF module 730 may include a first amplifier 7311 and a first coupler 7312, and the second RF module 740 may include a second amplifier 7411 and a second coupler 7412. When compared to FIG. 4A, FIG. 7 illustrates one or more embodiments in which a coupler switch (e.g., the coupler switch 470 of FIG. 4A) is not included in the first RF module 430, and is disposed outside the first RF module 430 and the second RF module 440.

According to another embodiment, the coupler switch 770 may be included in the second RF module 440.

In the example of FIG. 7, the coupler switch 770 is disposed only in a different location, and the configurations and the functions of the processor 710, the transceiver 720, the first RF module 730 including the first amplifier 7311 and the first coupler 7312, the second RF module 740 including the second amplifier 7411 and the second coupler 7412, the first antenna 750 and the second antenna 760, and the coupler switch 770 may be substantially the same as those of the processor 410, the transceiver 420, the first RF module 430, the second RF module 440, the first antenna 450 and second antenna 460, and the coupler switch 470 illustrated in FIG. 4A.

According to one or more embodiments, the coupler switch 770 may include a plurality of switches (e.g., switches 771, 772, 773, 774, 775, and 776) and a filter 780. Under control performed by the processor 710, the coupler switch 770 may enable a first feedback signal (FB_1) or a second feedback signal (FB_2) to be transmitted to the transceiver 420 alternately in a time division manner via a switching operation performed by each switch (e.g., switches 771, 772, 773, 774, 775, and 776).

An electronic device (e.g., the electronic device 101 of FIG. 1, the electronic device 101 of FIG. 2, the electronic device 101 of FIG. 4A, the electronic device 101 of FIG. 7) according to one or more embodiments may include a processor (e.g., the processor 120 of FIG. 2, the processor 120 of FIG. 2, the first communication processor of FIG. 2 or the second communication processor 214 of FIG. 2, the processor 410 of FIG. 4A, the processor 710 of FIG. 7), a transceiver (e.g., the transceiver 420 of FIG. 4A, the transceiver 720 of FIG. 7), a first RF module (e.g., the first RFFE 232 of FIG. 2, the first RF module 430 of FIG. 4A, the first RF module 730 of FIG. 7) including a first amplifier (e.g., the first amplifier 4311 of FIG. 4A, the first amplifier 7311 of FIG. 7) configured to amplify a signal of a first frequency band and a first coupler (e.g., the first coupler 4313 of FIG. 4A, the first coupler 7313 of FIG. 7) configured to generate a first feedback signal with respect to the signals of the first frequency band, a second RF module (e.g., the second RFFE 234 of FIG. 2, the second RF module 440 of FIG. 4A, the second RF module 740 of FIG. 7) including a second amplifier (e.g., the second amplifier 4411 of FIG. 4A, the second amplifier 4411 of FIG. 7) configured to amplify signals of a second frequency band and a second coupler (e.g., the second coupler 4413 of FIG. 4A, the second coupler 7413 of FIG. 7) configured to generate a second feedback signal with respect to the signals of the second frequency band, and a coupler switch (e.g., the coupler switch 470 of FIG. 1, the coupler switch 770 of FIG. 7) including a filter (e.g., the filter 480 of FIG. 4A, the filter 780 of FIG. 7) that enables signals of the first frequency band (e.g., the signals of the first frequency band, which is amplified by the first amplifier 4311) to pass through the filter and attenuates signals of the second frequency band (e.g., the signals of the second frequency band, which is amplified by the second amplifier 4411), and including a plurality of switches, and the coupler switch 470 and 770 may be configured to selectively switch between a first path in which the first feedback signal passes through the filter 480 and 780 and is transferred to the transceiver 420 and 720 and a second path in which the second feedback signal is transferred to the transceiver 420 and 720 without passing through the filter 480 and 780, and the processor 410 and 710 may be configured to control operation of the coupler switch 470 and 770 so as to alternately connect to the first path or the second path when operating in an operation mode that simultaneously transmits signals of the first frequency band (e.g., the signals of the first frequency band, which is amplified by the first amplifier 4311) and signals of the second frequency band (e.g., the signals of the second frequency band, which is amplified by the second amplifier 4411). The first RF module and the second RF module may be embodied as at least a part of a single chip or a single package.

According to one or more embodiments, the plurality of switches may include a first switch (e.g., the first switch 471 of FIG. 4A, the first switch 771 of FIG. 7A) configured to selectively connect an output end (FB_out), which outputs the first feedback signal or the second feedback signal to the transceiver 420 and 720, with the first path that passes through the filter 480 and 780 and the second path that does not pass through the filter 480 and 780, a second switch (e.g., the second switch 472 of FIG. 4A, the first switch 772 of FIG. 7A) configured to selectively connect an input end (FB_in), to which the first feedback signal or the second feedback signal is input, with the first path that passes through the filter 480 and 780 and the second path that does not pass through the filter 480 and 780, a third switch (e.g., the third switch 473 of FIG. 4A, the first switch 773 of FIG. 7A) configured to selectively connect the first coupler and the input end (FB_in), and a fourth switch (e.g., the fourth switch 474 of FIG. 4A, the fourth switch 774 of FIG. FIG. 7A) configured to selectively connect the second coupler and the input end (FB_in).

According to one or more embodiments, the first switch and the second switch may be embodied as single-pole-double-throw (SP2T) structures, and the third switch and the fourth switch may be embodied as single-pole-single-throw (SPST) structures.

According to one or more embodiments, the transceiver 420 and 720 may include a single input port connected to the output end (FB_out) of the coupler switch 470 and 770.

According to one or more embodiments, the processor 410 and 710 may perform control to turn on (ON) the third switch 473 that connects the first coupler and the input end (FB_in), and to turn on (ON) the first switch and the second switch to connect to the first path that passes through the filter 480 and 780, so as to connect the output end (FB_out) and the transceiver 420 and 720 in a first time interval, and may perform control to turn on (ON) the fourth switch that connects the second coupler and the input end (FB_in), and to turn on (ON) the first switch and the second switch to connect to the second path that does not pass through the filter 480 and 780, so as to connect the output end (FB_out) and the transceiver in a second time interval subsequent to the first time interval.

According to one or more embodiments, the processor 410 and 710 may be configured to alternately control the first time interval and the second time interval according to a time division condition of the first RF module 430 and 730 and the second RF module 440 and 740.

According to one or more embodiments, the first coupler and the second coupler may include at least one of bidirectional couplers configured to generate a forward coupling signal and a reverse coupling signal.

According to one or more embodiments, the second frequency band is a frequency band different from the first frequency band.

According to one or more embodiments, the electronic device 101 may support an E-UTRAN NR-dual connectivity (EN-DC), the first RF module 430 and 730 configured to generate a first transmission signal to be transmitted to a first cellular network, and the second RF module 440 and 740 configured to generate a second transmission signal to be transmitted to a second cellular network.

According to one or more embodiments, in case N different communication circuits that process signals of different frequency bands are included, the coupler switch 470 and 770 may further include an N^{th} switch that selectively connects the input end and each coupler in a different communication circuit.

According to one or more embodiments, in case N different communication circuits that process signals of different frequency bands are included, the coupler switch 470 and 770 may further include an Nth switch that selectively connects the input end and each coupler in a different communication circuit.

According to one or more embodiments, the coupler switch 470 and 770 may be configured as a module separate from the first RF module 430 and 730 and the second RF module 440 and 740.

According to one or more embodiments, the coupler switch 470 and 770 may be configured as a switch module.

According to one or more embodiments, a communication device that supports multiple frequency bands may include a transceiver (e.g., the transceiver 420 of FIG. 4A, the transceiver 420 of FIG. 7), a first RF module (e.g., the first RFFE 232 of FIG. 2, the first RF module 430 of FIG. 4A, the first RF module 730 of FIG. 7) including a first amplifier (e.g., the first amplifier 4311 of FIG. 4a, the first amplifier 7311 of FIG. 7) configured to amplify signals of a first frequency band and a first coupler (e.g., the first coupler 4313 of FIG. 4A, the first coupler 7313 of FIG. 7) configured to generate a first feedback signal with respect to the signals of the first frequency band, a second RF module (e.g., the second RFFE 234 of FIG. 2, the second RF module 440 of FIG. 4A, the second RF module 740 of FIG. 7) including a second amplifier (e.g., the second amplifier 4411 of FIG. 4A, the second amplifier 4411 of FIG. 7) configured to amplify signals of a second frequency band and a second coupler (e.g., the second coupler 4413 of FIG. 4A, the second coupler 7413 of FIG. 7) configured to generate a second feedback signal with respect to the signals of the second frequency band, and a coupler switch (e.g., the coupler switch 470 of FIG. 1, the coupler switch 770 of FIG. 7) configured to selectively transfer the first feedback signal or the second feedback signal to the transceiver according to a time division condition, and the coupler switch (e.g., the coupler switch 470 of FIG. 1 and the coupler switch 770 of FIG. 7) may include a filter (e.g., the filter 480 of FIG. 4A, the filter 780 of FIG. 7) that enables signals of the first frequency band (e.g., the signals of the first frequency band, which is amplified by the first amplifier 4311) to pass through the filter and attenuates signals of the second frequency band (e.g., the signals of the second frequency band, which is amplified by the second amplifier 4411), a first switch (e.g., the first switch 471 of FIG. 4a, the first switch 771 of FIG. 7A) configured to selectively connect an output end (FB_out), which is connected to the transceiver, with the first path that passes through the filter and the second path that does not pass through the filter, a second switch (e.g., the second switch 472 of FIG. 4A, the second switch 772 of FIG. 7A) configured to selectively connect an input end (FB_in) with the first path that passes through the filter and the second path that does not pass through the filter, a third switch (e.g., the third switch 473 of FIG. 4A, the third switch 773 of FIG. 7A) configured to selectively connect the first coupler and the input end (FB_in), and a fourth switch (e.g., the fourth switch 474 of FIG. 4A, the fourth switch 774 of FIG. 7A) configured to selectively connect the second coupler and the input end (FB_in).

According to one or more embodiments, the communication device may further include a processor (e.g., the processor 120 of FIG. 1, the processor 120 of FIG. 2, the first communication processor 212 of FIG. 2 or the second communication processor 214 of FIG. 2, the processor 120 of FIG. 2, the processor 410 of FIG. 4A, the processor 710 of FIG. 7), and the processor 1410 and 710 may perform control to turn on (ON) the third switch 473 and 773 that connects the first coupler 4313 and 4413 and the input end (FB_in), and to turn on (ON) the first switch 471 and 771 and the second switch 472 and 772 to connect to the first path that passes through the filter, so as to connect the output end (FB_out) and the transceiver 420 and 720 in a first time interval, and perform control to turn on (ON) the fourth switch 474 and 774 that connects the second coupler 4413 and 7413 and the input end (FB_in), and to turn on (ON) the first switch 471 and 771 and the second switch 472 and 772 to connect to the second path that does not pass through the filter, so as to connect the output end (FB_out) and the transceiver in a second time interval subsequent to the first time interval.

According to one or more embodiments, the processor 410 and 710 of the communication device may be configured to alternately control the first time interval and the second time interval according to a time division condition of the first module RF 430 and 730 and the second RF module 440 and 740.

According to one or more embodiments, the transceiver 420 and 720 of the communication device may include a single input port connected to the output end (FB_out) of the coupler switch 470 and 770.

According to one or more embodiments, the communication device may further include a third RF module including a third amplifier configured to amplify signals of a third frequency band different from the first frequency band and the second frequency band, and a third coupler configured to generate a third feedback signal with respect to the signals of the third frequency band, and the coupler switch 470 and 770 may further include a fifth switch configured to selectively connect the third coupler and the input end (FB_in).

According to one or more embodiments, in the communication device, the first switch 471 and 771 and the second switch 472 and 772 may be embodied as single-pole-double-throw (SP2T) structures, and the third switch 473 and 773 and the fourth switch 474 and 774 may be embodied as single-pole-single-throw (SPST) structures.

According to one or more embodiments, the first coupler (4313, 7313) and the second coupler (4413, 7413) may include at least one of bidirectional couplers configured to generate a forward coupling signal and a reverse coupling signal. It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a processor;
a first radio frequency (RF) module;
a second RF module;
a coupler switch operatively connected to the first RF module and the second RF module; and
a transceiver operatively connected to the processor, the coupler switch, and the first RF module, and the second RF module,
wherein the first RF module comprises:
a first amplifier configured to amplify signals of a first frequency band, and
a first coupler configured to generate a first feedback signal with respect to the signals of the first frequency band,
wherein the second RF module comprises:
a second amplifier configured to amplify signals of a second frequency band, and
a second coupler configured to generate a second feedback signal with respect to the signals of the second frequency band, and
wherein the coupler switch comprises:
a filter configured to pass the signals of the first frequency band and to attenuate the signals of the second frequency band, and
a plurality of switches,
wherein the coupler switch is configured to selectively switch between a first path in which the first feedback signal passes through the filter, the first feedback signal being transferred to the transceiver and a second path in which the second feedback signal is transferred to the transceiver without passing through the filter, and
wherein the processor is configured to alternately connect the coupler switch to the first path or the second path, based on an operation mode for transmitting the signals of the first frequency band and the signals of the second frequency band.

2. The electronic device of claim 1, wherein the plurality of switches comprises:
a first switch configured to selectively connect an output end of the coupler switch with the first path that passes through the filter and the second path that does not pass through the filter, wherein the output end of the coupler switch outputs the first feedback signal or the second feedback signal to the transceiver;
a second switch configured to selectively connect an input end with the first path that passes through the filter and the second path that does not pass through the filter, wherein the first feedback signal or the second feedback signal is input to the input end;
a third switch configured to selectively connect the first coupler and the input end; and
a fourth switch configured to selectively connect the second coupler and the input end.

3. The electronic device of claim 2, wherein the first switch and the second switch have a single-pole-double-throw (SP2T) structure, and
wherein the third switch and the fourth switch have a single-pole-single-throw (SPST) structure.

4. The electronic device of claim 2, wherein the transceiver comprises a single input port connected to the output end of the coupler switch.

5. The electronic device of claim 2, wherein the processor is configured to:
control the coupler switch to turn on the third switch that connects the first coupler and the input end, and turn on the first switch and the second switch to connect to the first path that passes through the filter, so as to connect the output end and the transceiver in a first time interval; and
control the coupler switch to turn on the fourth switch that connects the second coupler and the input end, and turn on the first switch and the second switch to connect to the second path that does not pass through the filter, so as to connect the output end and the transceiver in a second time interval subsequent to the first time interval.

6. The electronic device of claim 5, wherein the processor is further configured to alternately control the first time interval and the second time interval, based on a time division condition of the first RF module and the second RF module.

7. The electronic device of claim 6, wherein the first coupler and the second coupler comprise at least one of bidirectional couplers configured to generate a forward coupling signal and a reverse coupling signal.

8. The electronic device of claim 6, wherein the second frequency band is different from the first frequency band.

9. The electronic device of claim 6, wherein the electronic device supports an E-UTRAN NR-dual connectivity (EN-DC),
wherein the first RF module is configured to generate a first transmission signal to be transmitted to a first cellular network, and
wherein the second RF module is configured to generate a second transmission signal to be transmitted to a second cellular network.

10. The electronic device of claim 6, wherein the coupler switch further comprises an N^{th} switch that selectively connects the input end and each coupler in N communication circuits.

11. The electronic device of claim 1, wherein the coupler switch is provided in the first RF module or the second RF module.

12. The electronic device of claim 1, wherein the coupler switch is separate from the first RF module and the second RF module.

13. The electronic device of claim 1, wherein the coupler switch is a switch module.

14. A communication device for supporting multiple frequency bands, the communication device comprising:
a first radio frequency (RF) module;
a second RF module;
a coupler switch operatively connected to the first RF module and the second RF module; and
a transceiver operatively connected to the first RF module, the second RF module, and the coupler switch,
wherein the first RF module comprises:
a first amplifier configured to amplify signals of a first frequency band, and
a first coupler configured to generate a first feedback signal with respect to the signals of the first frequency band;
wherein the second RF module comprises:
a second amplifier configured to amplify signals of a second frequency band, and
a second coupler configured to generate a second feedback signal with respect to the signals of the second frequency band; and
wherein the coupler switch is configured to selectively transfer the first feedback signal or the second feedback signal to the transceiver based on a time division condition,
wherein the coupler switch comprises:
a filter configured to pass the signals of the first frequency band to pass, and attenuate the signals of the second frequency band;
a first switch configured to selectively connect an output end with a first path that passes through the filter and a second path that does not pass through the filter, wherein the output end is connected to the transceiver;
a second switch configured to selectively connect an input end with the first path that passes through the filter and the second path that does not pass through the filter;
a third switch configured to selectively connect the first coupler and the input end; and
a fourth switch configured to selectively connect the second coupler and the input end.

15. The communication device of claim 14, further comprising a processor configured to:
control the coupler switch to turn on the third switch that connects the first coupler and the input end, and turn on the first switch and the second switch to connect to the first path that passes through the filter, so as to connect the output end and the transceiver in a first time interval; and
control the coupler switch to turn on the fourth switch that connects the second coupler and the input end, and turn on the first switch and the second switch to connect to the second path that does not pass through the filter, so as to connect the output end and the transceiver in a second time interval subsequent to the first time interval.

16. The communication device of claim 15, wherein the processor is further configured to alternately control the first time interval and the second time interval based on a time division condition of the first RF module and the second RF module.

17. The communication device of claim 14, wherein the transceiver comprises a single input port connected to the output end of the coupler switch.

18. The communication device of claim 14, further comprising a third RF module comprising:
a third amplifier configured to amplify signals of a third frequency band different from the first frequency band and the second frequency band; and
a third coupler configured to generate a third feedback signal with respect to the signals of the third frequency band,
wherein the coupler switch further comprises a fifth switch configured to selectively connect the third coupler and the input end.

19. The communication device of claim 14, wherein the first switch and the second switch have a single-pole-double-throw (SP2T) structure, and
wherein the third switch and the fourth switch have a single-pole-single-throw (SPST) structure.

20. The communication device of claim 14, wherein the first coupler and the second coupler comprise at least one bidirectional coupler configured to generate a forward coupling signal and a reverse coupling signal.
